(19) United States
(12) Patent Application Publication
(10) Pub. No.: US 2026/0164120 A1
(43) Pub. Date: Jun. 11, 2026

(54) CONTROL METHOD AND CONTROL DEVICE FOR MONITORING EQUIPMENT AND MONITORING SYSTEM

(71) Applicant: INVENTEC APPLIANCES CORPORATION, New Taipei City (TW)

(72) Inventor: JIA-SHENG MEI, Nanjing City (CN)

(21) Appl. No.: 19/257,486

(22) Filed: Jul. 2, 2025

(30) Foreign Application Priority Data
Dec. 11, 2024 (CN) 202411819250.8

(51) Int. Cl. H04N 23/65; G06T 7/246; G06T 7/73; H04N 23/611

(52) U.S. Cl. CPC H04N 23/651; G06T 7/246; G06T 7/73; H04N 23/611; G06T 2207/10016; G06T 2207/30196; G06T 2207/30232

(57) ABSTRACT

A control method and a control device of monitoring equipment and a monitoring system. The control method includes: collecting a monitoring image captured by the monitoring equipment and a weight setting range; dividing the monitoring image into a plurality of sub-images arranged in an array format; setting a weight value of each sub-image according to the monitoring image and the weight setting range, each weight value being within the weight setting range; controlling the monitoring equipment to capture the monitoring image; collecting a sub-movement value of each sub-image in real time; determining a monitoring power level of the monitoring equipment according to the sub-movement value of each sub-area; and controlling the monitoring equipment to operate at the monitoring power level.

### CROSS-REFERENCE TO RELATED PATENT APPLICATION

This application claims priority to Chinese Patent Application No. 202411819250.8, filed on Dec. 11, 2024, the entire contents of which are incorporated herein by reference.

All references cited in this specification are incorporated herein by reference in their entireties. The citation of any reference is not an admission that such reference constitutes prior art.

### FIELD OF THE DISCLOSURE

The present disclosure relates to a video monitoring field, and more particularly, to a control method and a control device for a monitoring equipment and a monitoring system.

### BACKGROUND OF THE DISCLOSURE

Camera-based on-site monitoring is widely used in the field of security. Cameras record image information via image sensors, which generate heat during operation. However, when the camera operates for too long, the working hour of the image sensors inside the camera is increased and greater heat is produced.

Monitoring equipment has been widely used in various fields. In order to ensure the timeliness of the monitoring work, the cameras are usually required to work uninterruptedly for 24 hours a day. Prolonged operation can cause the camera to experience high temperatures, leading to issues such as increased noise, focus drift, and color deviation, thereby affecting image quality and camera stability. In addition, the high temperature generated by the camera may also damage the image sensing electronic components or image sensing optical components inside the camera, which reduce the service life of the camera.

### SUMMARY OF THE DISCLOSURE

In response to the above-referenced technical inadequacy, the present disclosure provides a control method and a control device for a monitoring equipment and a monitoring system.

In order to solve the above-mentioned problem, one aspect of the present disclosure provides a control method for a monitoring equipment. The control method includes: collecting, by a monitoring image and weight acquisition module, a monitoring image captured by the monitoring equipment and a weight setting range; dividing, by a monitoring image and weight acquisition module, the monitoring image into a plurality of sub-images arranged in an array format; setting, by a weight setting module, a weight value of each sub-image according to the monitoring image and the weight setting range, in which each weight value is within the weight setting range; controlling, by a sub-movement value acquisition module, the monitoring equipment to capture the monitoring image; collecting, by the sub-movement value acquisition module, a sub-movement value of each sub-image in real time; determining, by a power level determination module, a monitoring power level of the monitoring equipment according to the sub-movement value of each sub-area; and controlling, by the power level determination module, the monitoring equipment to operate at the monitoring power level.

In order to solve the above-mentioned problem, another one aspect of the present disclosure provides a control device for monitoring equipment. The control device includes: a monitoring image and weight acquisition module configured to collect a monitoring image captured by the monitoring equipment and a weight setting range and to divide the monitoring image into a plurality of sub-images arranged in an array format; a weight value setting module configured to set a weight value of each sub-image according to the monitoring image and the weight setting range, in which the weight value is within the weight setting range; a sub-movement value acquisition module configured to control the monitoring equipment to capture the monitoring image in real time and to collect a sub-movement value of each sub-image in real time; and a power level determination module configured to determine a monitoring power level of the monitoring equipment according to the sub-movement value of each sub-image and the weight value of each sub-image and to control the monitoring equipment to operate at the monitoring power level.

In order to solve the above-mentioned problem, another one aspect of the present disclosure provides a monitoring system. The monitoring system includes a monitoring equipment and a controller. The controller is communicatively connected to the monitoring equipment and the controller is configured to perform the control method of the monitoring equipment.

### BRIEF DESCRIPTION OF THE DRAWINGS

The described embodiments may be better understood by reference to the following description and the accompanying drawings, in which:

FIG. 1 is a flowchart of a control method for monitoring equipment according to a first embodiment of the present disclosure;

FIG. 2 is a flowchart of the control method for the monitoring equipment according to a second embodiment of the present disclosure;

FIG. 3 is a flowchart of the control method for the monitoring equipment according to a third embodiment of the present disclosure;

FIG. 4 is a flowchart of the control method for the monitoring equipment according to a fourth embodiment of the present disclosure;

FIG. 5 is a flowchart of the control method for the monitoring equipment according to a fifth embodiment of the present disclosure;

FIG. 6 is a schematic diagram of a control device for the monitoring equipment according to one embodiment of the present disclosure;

FIG. 7 is a schematic diagram of a monitoring system according to one embodiment of the present disclosure; and

FIG. 8 is a schematic diagram of a monitoring image according to one embodiment of the present disclosure.

### DETAILED DESCRIPTION OF THE EXEMPLARY EMBODIMENTS

The present disclosure will now be described in detail with reference to the following illustrative embodiments. Like reference numbers refer to like elements throughout the drawings. As used in the description herein and throughout the claims that follow, unless the context clearly dictates otherwise, the meaning of “a,” “an” and “the” includes plural reference, and the meaning of “in” includes “in” and “on.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

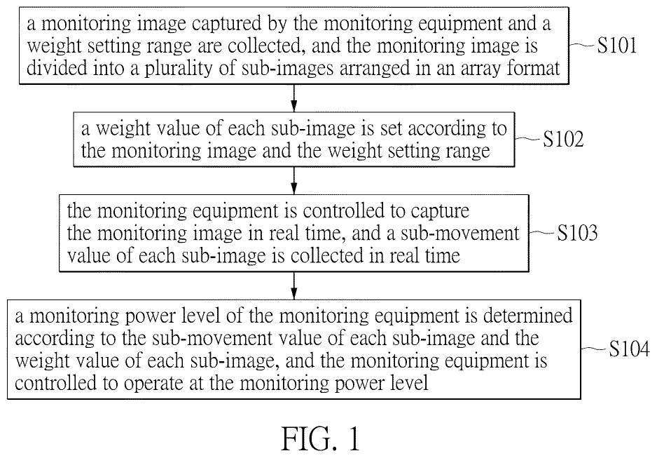

FIG. 1 is a flowchart of a control method for a monitoring equipment according to a first embodiment of the present disclosure. The control method includes steps S101˜S104.

In step S101, a monitoring image captured by the monitoring equipment and a weight setting range are collected, and the monitoring image is divided into a plurality of sub-images arranged in an array format.

The monitoring equipment includes a camera lens, and the monitoring image refers to an image captured by the monitoring equipment at the current position during operation. The weight setting range may be determined based on actual requirements. In one embodiment, the weight setting range is from 0 to 9, but is not limited thereto.

When the monitoring equipment is installed, in order to make the images captured by the monitoring equipment reflect actual situations of a monitoring area, a position of the monitoring equipment is usually adjusted, and the monitoring images captured by the monitoring equipment at various positions are captured. When the monitoring images captured by the monitoring equipment meet an actual requirement, the position of the monitoring equipment is fixed, and the monitoring image captured by the monitoring device at each moment reflect a real-time situation of the same monitoring area. When the monitoring equipment is turned on, the monitoring image can be collected through an image processing module of the monitoring equipment, and then the monitoring image can be divided into a plurality of sub-images arranged in an array format according to the actual requirement, so as to set a weight value of each sub-image. The size of each sub-image may be set based on parameters of the monitoring image, such as its resolution. For example, if the monitoring image has a resolution of 1280×720 pixels, it may be divided into 8 rows and 6 columns, resulting in sub-images of 160×120 pixels each.

In step S102, a weight value of each sub-image is set according to the monitoring image and the weight setting range, wherein each weight value is within the weight setting range.

The weight value of each sub-image may be set based on the user's attention level to each sub-image. Preferably, a higher attention level corresponds to a higher weight value, and a lower attention corresponds to a lower weight value. The weight value indicates the user's attention level of the sub-image.

In step S103, the monitoring equipment is controlled to capture the monitoring image in real time, and a sub-movement value of each sub-image is collected in real time, wherein the sub-movement value represents a difference between a previous frame and a subsequent frame.

The monitoring images captured in real time comprise multiple frames, and the sub-movement value for each sub-image is determined by comparing the corresponding sub-image in consecutive frames. For example, if a sub-image in the next frame is identical to that in the previous frame, its sub-movement value is 0; if different, the sub-movement value is 1.

In step S104, a monitoring power level of the monitoring equipment is determined according to the sub-movement value of each sub-image and the weight value of each sub-image, and the monitoring equipment is controlled to operate at the monitoring power level, wherein the higher the monitoring power level is, the greater the heat generated by internal components of the monitoring equipment is.

A current total movement value of the monitoring image is calculated based on the sub-movement value and the weight value of each sub-image. The monitoring power level of the monitoring equipment is determined according to the current total movement value. The current total movement value indicates the degree of change in the monitoring image. A larger total movement value corresponds to a greater change and a higher monitoring power level. Operating the monitoring equipment at a higher power level ensures image clarity. When the total movement value is lower, the monitoring power level is reduced, thereby decreasing the heat generated by the monitoring equipment and allowing dissipation of accumulated thermal energy, which helps minimize temperature-related impacts on equipment operation. Accordingly, the monitoring equipment dynamically adjusts its power level throughout a working period based on the sub-movement and weight values. This dynamic adjustment prevents prolonged operation at a high power level. Prolonged operation at a high power level can otherwise lead to excessive heat accumulation and a degradation of monitoring quality.

The monitoring image is divided into the plurality of sub-images, for example, arranged in an array format. A weight value is set for each sub-image according to a predefined importance, such as a user's level of attention for that sub-image's corresponding region. Because the sub-movement values in the various sub-images can change over time, the determined monitoring power level is also dynamic, varying throughout a working period of the monitoring equipment. Operating at a lower power level provides several advantages. It reduces the operating temperature and allows for effective heat dissipation from internal components. This, in turn, minimizes the time the equipment operates at elevated temperatures and can prevent it from reaching detrimental temperature thresholds. Consequently, both the monitoring quality and the service life of the monitoring equipment are improved.

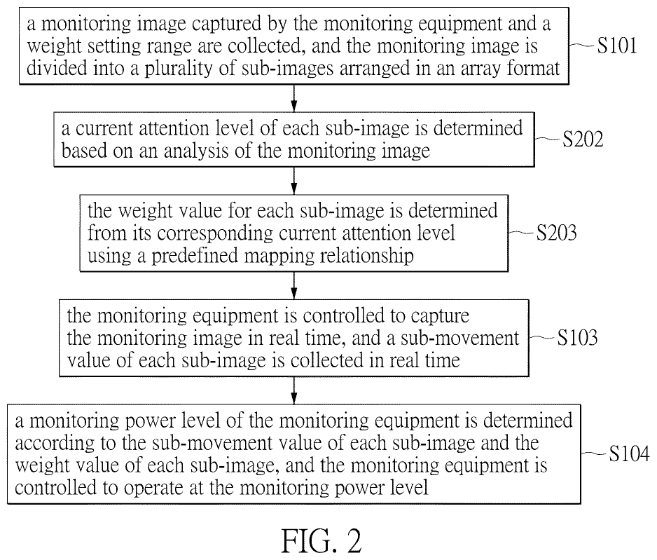

FIG. 2 is a flowchart of the control method for the monitoring equipment according to a second embodiment of the present disclosure. The control method includes steps S101, S202, S203, S103 and S104.

In step S202, a current attention level of each sub-image is determined based on an analysis of the monitoring image.

A monitoring area corresponds to the monitoring image, with sub-areas of the monitoring area corresponding to the respective sub-images. The sub-images can be defined based on features identified within the monitoring image. In one non-limiting embodiment, an automated, rule-based system assigns attention levels. For instance, regions corresponding to potential points of ingress or egress, such as windows or doors, are identified. The sub-images containing these points of ingress/egress (e.g., a first sub-area with a window) are assigned a “highest” attention level. Subsequently, regions adjacent to these high-priority areas (e.g., a second sub-area with a door accessible from the first sub-area) may be assigned a “secondary highest” attention level. Other sub-areas, such as those forming a likely path between the first and second sub-areas, may be assigned a “secondary lowest” attention level. Remaining sub-areas deemed less critical are assigned a “lowest” attention level. These attention levels can be represented numerically. For example, a percentage value may be used, where 80-100% signifies the highest level, 50-80% the secondary highest, 10-50% the secondary lowest, and below 10% the lowest. It is understood that other methods for assigning attention levels and other numerical schemes may be used.

The attention level for each sub-image can be set via at least two modes. In a first mode, a user directly assigns the attention level for each sub-image, for example, through a graphical user interface (GUI). In a second mode, a processing module of the monitoring equipment automatically proposes an initial set of attention levels based on its internal processing logic (e.g., the rule-based system of). The user can then review, approve, or modify these proposed levels. The final, user-approved or modified levels are then used as the current attention levels.

In step S203, the weight value for each sub-image is determined from its corresponding current attention level using a predefined mapping relationship.

The mapping relationship may be embodied as, for example, a look-up table, a curve graph, or a mathematical function. This relationship can be empirically derived, pre-configured, or learned over time.

When the mapping relationship is the curve graph of the current attention level and the weight setting value, after a current attention level is captured, a weight setting value of the curve graph corresponding to the captured current attention level is determined to be a weight value. Alternatively, when the mapping relationship is the table of the current attention level and the weight setting value, after a current attention level is captured, a weight setting value corresponding to the captured current attention level can be looked up in the table and is determined to be a weight value. The weight value positively correlated with the current attention level, that is, the higher the current attention level is, the larger the weight value is.

FIG. 8 is a schematic diagram illustrating an exemplary assignment of weight values to a monitoring image, according to one embodiment of the present disclosure. In this non-limiting example, the weight setting range is between 0˜9. The weight value of the sub-image with the “highest” attention level is set as 9, the weight value of the sub-image with the “secondary highest” attention level is set as 3, the weight value of the sub-image with the “secondary lowest” attention level is set as 1, and the weight value of the sub-image with the “lowest” attention level is set as 0.

The weight value of each sub-image is thus set based on identified image features and/or user-defined attention levels. By numerically quantifying the importance of each sub-image via its weight value, the subsequent determination of the monitoring power level becomes more precise and context-aware.

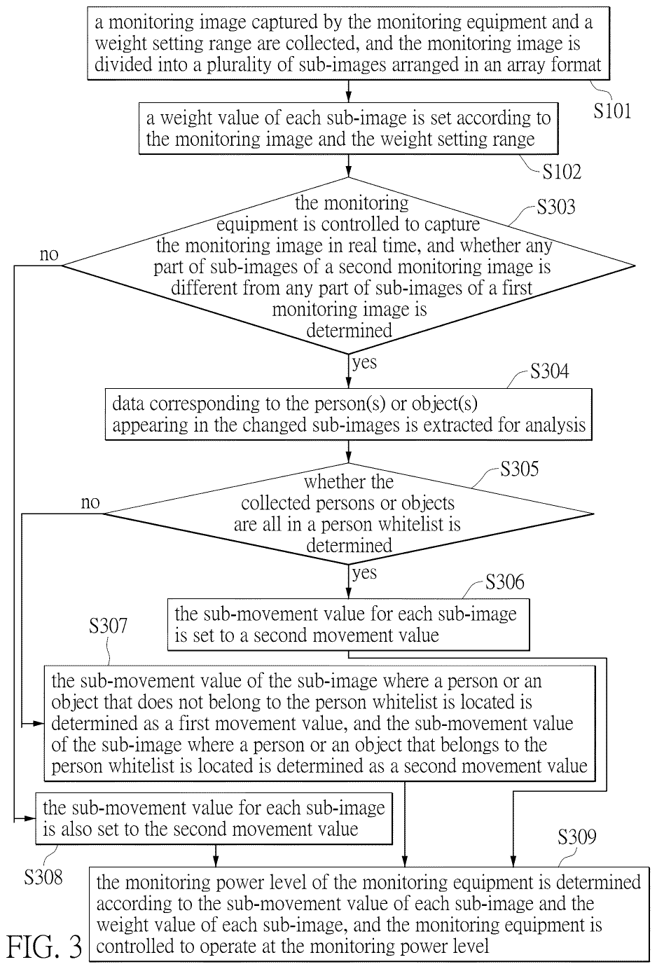

FIG. 3 is a flowchart of the control method for the monitoring equipment according to a third embodiment of the present disclosure, and the control method includes step S101, S102, S303˜S309.

In step S303, the monitoring equipment is controlled to capture the monitoring image in real time, and whether any part of sub-images of a second monitoring image is different from any part of sub-images of a first monitoring image is determined; if so, step S304 is performed; if not, step S308 is performed.

The first monitoring image is an image of a previous frame captured by the monitoring equipment, and the second monitoring image is an image of the subsequent frame captured by the monitoring equipment. Dynamic image is composed of static images of several frames captured by the monitoring equipment within a unit time, that is, a video image captured by the monitoring equipment is the dynamic image formed by the continuous playback of the static images captured by the monitoring equipment.

The monitoring equipment is controlled to capture the monitoring image in real time so as to capture images of several frames. By comparing the second monitoring image with the first, a difference in any corresponding sub-images is indicative of movement of a person or objects within the monitoring area. Conversely, an absence of differences indicates no movement.

In step S304, data corresponding to the person(s) or object(s) appearing in the changed sub-images is extracted for analysis.

This extraction is performed because, at this stage, the identity of the detected person or object is unknown. The extracted data is analyzed to determine whether the person or object is authorized or recognized, and this analysis result subsequently influences the power level determination.

In step S305, whether the collected persons or objects are all in a person whitelist is determined; if so, step S306 is performed; if not, step S307 is performed.

The whitelist contains feature data for authorized or recognized entities. For example, in a residential setting, these entities may include residents of the house and their pets (e.g., cats, dogs). The feature data for a person can include facial features, height, or gait, while feature data for an object or pet can include its shape, size, or outline.

The feature data of the extracted person(s) or object(s) is compared against the feature data stored in the whitelist. A match indicates the entity is on the whitelist.

In step S306, the sub-movement value for each sub-image is set to a “second movement value”. The second movement value is typically a low value, for example, zero, indicating that the detected movement is to be disregarded.

In step S308, the sub-movement value for each sub-image is also set to the second movement value.

When all detected moving entities are on the whitelist, the system deems the situation secure. Consequently, the sub-movement values for all sub-images (both those with detected movement and those without) are set to the second movement value. This effectively treats movement by whitelisted entities as non-events for the purpose of power level calculation, preventing the monitoring equipment from unnecessarily operating at a high power level due to authorized movements.

In step S307, the sub-movement value of the sub-image where a person or an object that does not belong to the person whitelist is located is determined as a first movement value, and the sub-movement value of the sub-image where a person or an object that belongs to the person whitelist is located is determined as a second movement value.

The first movement value is greater than the second movement value. The first movement value can be a fixed value (e.g., 1) or a variable value. For instance, it can be calculated based on the degree of difference between the preceding and subsequent sub-images, such as a ratio of the changed area to the total area of the sub-image. In one exemplary embodiment, the first movement value is 1, and the second movement value is 0.

In summary, if an unauthorized person or object is detected, the sub-movement value of the corresponding sub-image is set to the higher first movement value, while all other sub-images are assigned the lower second movement value.

In step S309, the monitoring power level of the monitoring equipment is determined according to the sub-movement value of each sub-image and the weight value of each sub-image, and the monitoring equipment is controlled to operate at the monitoring power level.

By implementing the whitelist, the system can intelligently differentiate between authorized and unauthorized movements. Movements by authorized entities are effectively disregarded by assigning them a low (or zero) sub-movement value. This ensures that only potentially significant events (i.e., the presence of unauthorized entities) trigger a higher total movement value, leading to a more accurate and efficient determination of the required monitoring power level and thereby extending the service life of the equipment.

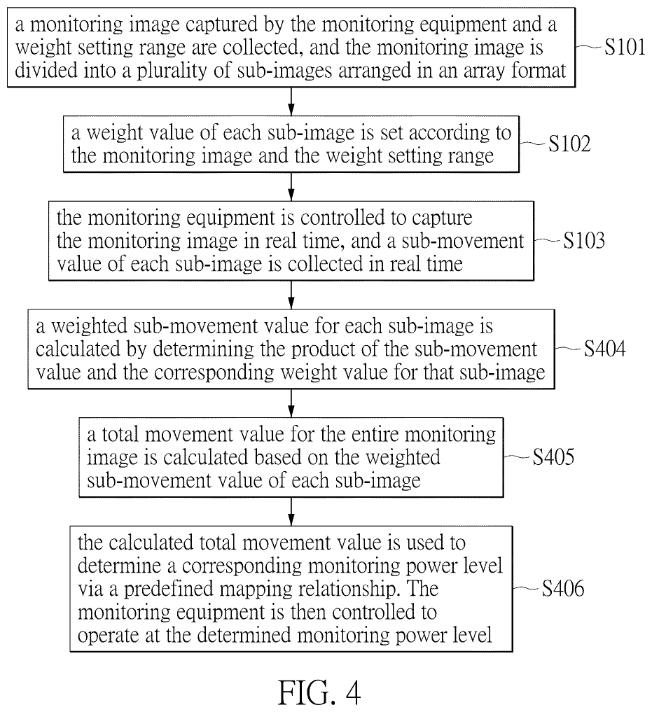

FIG. 4 is a flowchart of the control method for the monitoring equipment according to a fourth embodiment of the present disclosure, the control method includes steps S101˜S103, and S404˜S406.

In step S404, a weighted sub-movement value for each sub-image is calculated by determining the product of the sub-movement value and the corresponding weight value for that sub-image.

The weighted sub-movement value thus represents the raw sub-movement value as scaled by the importance (i.e., the weight value) of the sub-image. Exemplarily, if a sub-movement value is 1 and its weight value is 0, the resulting weighted sub-movement value is 0; if a sub-movement value is 0.8 and its weight value is 1, the resulting weighted sub-movement value is 0.8; and if a sub-movement value is 1 and its weight value is 3, the resulting weighted sub-movement value is 3.

In step S405, a total movement value for the entire monitoring image is calculated based on the weighted sub-movement value of each sub-image.

The weighted sub-movement value of the sub-image can reflect a reference movement amount of the sub-image, and the total movement value can reflect a reference movement amount of the monitoring image. In a preferred embodiment, the sum of the weighted sub-movement values of the sub-images can be used as the total movement value of the monitoring image, so as to determine the monitoring power level based on the total movement value.

A matrix may be used to represent the sub-movement value, the weight value, and weighted sub-movement value of each sub-image. For example, the monitoring image is divided into m rows and n columns, and the number of the sub-images of the monitoring image are m*n. A matrix A is used to represent the sub-movement value of each sub-image of the monitoring image, another matrix B is used to represent the weight value of each sub-image of the monitoring image, and another matrix C is used to represent the weighted sub-movement value of each sub-image of the monitoring image.

$$A = ( \begin{matrix}{a}_{11} & … & {a}_{1 m} \\ ⋮ & ⋱ & ⋮ \\ {a}_{m 1} & … & {a}_{mn}\end{matrix} ) ; B = ( \begin{matrix}{b}_{11} & … & {b}_{1 n} \\ ⋮ & ⋱ & ⋮ \\ {b}_{m 1} & … & {b}_{mn}\end{matrix} ) ; C ( \begin{matrix}{a}_{11} {b}_{11} & … & {a}_{1 n} {b}_{1 n} \\ ⋮ & ⋱ & ⋮ \\ {a}_{m 1} {b}_{m 1} & … & {a}_{mn} {b}_{mn}\end{matrix} ) ;$$

where Matrix C is a Hadamard product of matrix A and matrix B, C=[aᵢⱼbᵢⱼ], i∈[1, m], and j∈[1, n].

The total movement value P of the monitoring image is the sum of all of the values of the matrix C.

$$P = {\sum }_{i = 1}^{m} {\sum }_{j = 1}^{n} ( {a}_{ij} {b}_{ij} ) .$$

In step S406, the calculated total movement value is used to determine a corresponding monitoring power level via a predefined mapping relationship. The monitoring equipment is then controlled to operate at the determined monitoring power level.

Generally, the monitoring power level is positively correlated with the total movement value, such that a higher total movement value results in a higher power level. A higher power level can, in turn, provide enhanced monitoring quality. This enhancement may be manifested as, for example, a higher video resolution, an increased video frame rate, or a higher audio sampling rate.

The mapping relationship can be implemented as a look-up table, a curve, or a set of rules. In one non-limiting embodiment using a look-up table (e.g., Table 1), the total movement value, denoted as B, is mapped to one of four discrete power levels:
a “fourth power level” is selected if B=0;
a “third power level” if 0<B≤36;
a “second power level” if 36<B≤92; and
a “first power level” if B>92.

These abstract power levels correspond to concrete hardware or software settings. For instance, for night vision, the levels might control the power supplied to an infrared LED: the ‘first power level’ may correspond to 100% of rated power for maximum clarity, while the second, third, and fourth levels may correspond to 80%, 60%, and 40% of rated power, respectively. In another embodiment, the mapping relationship is a continuous function, such as a logistic or sigmoid curve, allowing for a smooth transition between power levels rather than discrete steps.

TABLE 1

| current | | | | |
|---|---|---|---|---|
| total | | video | | |
| movement | power | resolution | video frame | audio sampling |
| amount [symbol] | level [symbol] | (px) [symbol] | rate (f/s) [symbol] | rate (kHz) [symbol] |
| >92 [symbol] | first [symbol] | 3840 × 2160 [symbol] | 25 [symbol] | 96 [symbol] |
| 36~92 [symbol] | second [symbol] | 2048 × 1536 [symbol] | 18 [symbol] | 48 [symbol] |
| 0~36 [symbol] | third [symbol] | 1290 × 1080 [symbol] | 10 [symbol] | 24 [symbol] |
| 0 [symbol] | fourth [symbol] | 1280 × 720 [symbol] | 5 [symbol] | 8 [symbol] |

In summary, a total movement value is calculated by first determining a weighted sub-movement value for each sub-image (i.e., the product of its sub-movement value and its weight value) and then aggregating these values (e.g., by summation). The resulting total movement value is then mapped to a specific monitoring power level, for instance by using a look-up table or a predefined function. This entire process allows the monitoring equipment to dynamically adjust its operating parameters in real time based on the contextual significance of detected movement. By avoiding prolonged operation at high power levels when unnecessary, the system reduces heat generation and thereby extends the service life of the equipment.

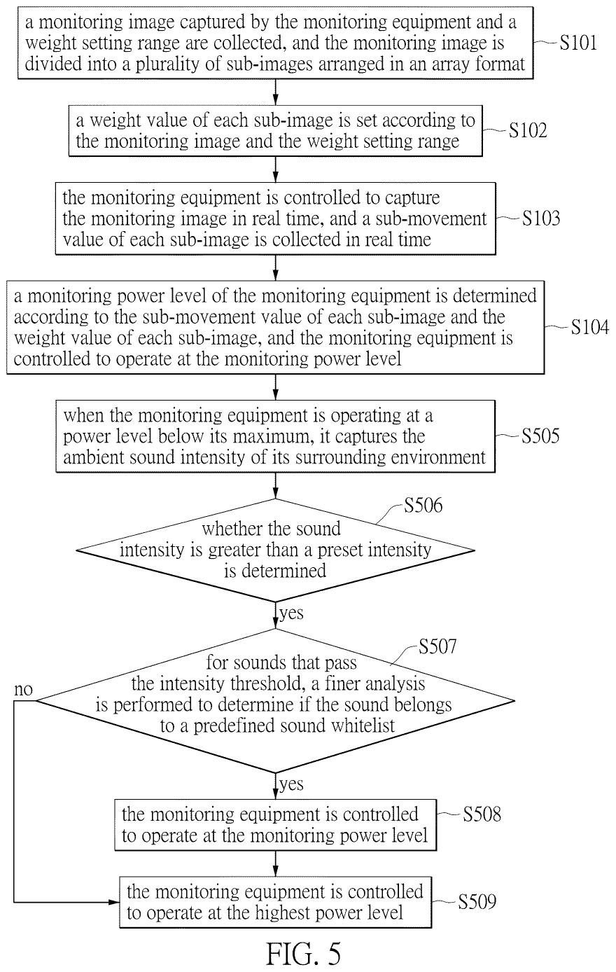

FIG. 5 is a flowchart of the control method for the monitoring equipment based on a fifth embodiment of the present disclosure, and the control method includes steps S101˜S104, S505˜S509.

In step S505, when the monitoring equipment is operating at a power level below its maximum (e.g., during a visually quiescent state), it captures the ambient sound intensity of its surrounding environment.

When the monitoring equipment operates at the highest power level, heat generated by the monitoring equipment is greater.

The rationale for this step is that a low power level, corresponding to a low total movement value, indicates a lack of visual activity. However, an important event may be preceded by auditory cues. Therefore, the system utilizes a sound detection device (e.g., an integrated microphone) to monitor the ambient sound level (e.g., its decibel value). By detecting significant sounds, the system can proactively adjust its working state (e.g., by increasing the monitoring power level) in anticipation of a sound-making entity entering the visual monitoring area. This preemptive adjustment improves monitoring reliability by ensuring that events occurring just outside or about to enter the field of view are not missed.

In step S506, whether the sound intensity is greater than a preset intensity is determined; if so, step S507 is performed.

The preset intensity may be a fixed value and may be set based on actual needs. Exemplarily, a decibel value of the preset intensity is 50 db.

When the sound intensity is greater than the preset intensity, an abnormal event, such as a sound of a person for help or a sound of a buzzer, may occur in the environment where the monitoring equipment is located, and the abnormal event has not yet entered into an area monitored by the monitoring equipment.

In step S507, for sounds that pass the intensity threshold, a finer analysis is performed to determine if the sound belongs to a predefined sound whitelist. This whitelist contains the acoustic signatures of known, benign sounds specific to the environment, such as the meow of a resident pet or the recurring sound of a seasonal insect (e.g., a cicada). An acoustic signature may be defined by features including, but not limited to, timbre, frequency spectrum, and periodicity. The signature of the detected sound is compared against the library of whitelisted signatures. If a match is found, the process proceeds to step S508; otherwise, it proceeds to step S509.

In step S508, the monitoring equipment is controlled to operate at the monitoring power level.

If the sound occurring is identified on the sound whitelist, it is deemed a benign or expected event. Consequently, the system takes no action and remains in its current monitoring state (e.g., a low-power state).

In step S509, the monitoring equipment is controlled to operate at the highest power level.

If the sound is not on the sound whitelist, it is treated as a potential threat or a significant unknown event. In response, the system is immediately controlled to operate at its highest power level to ensure maximum capture quality for any impending visual event.

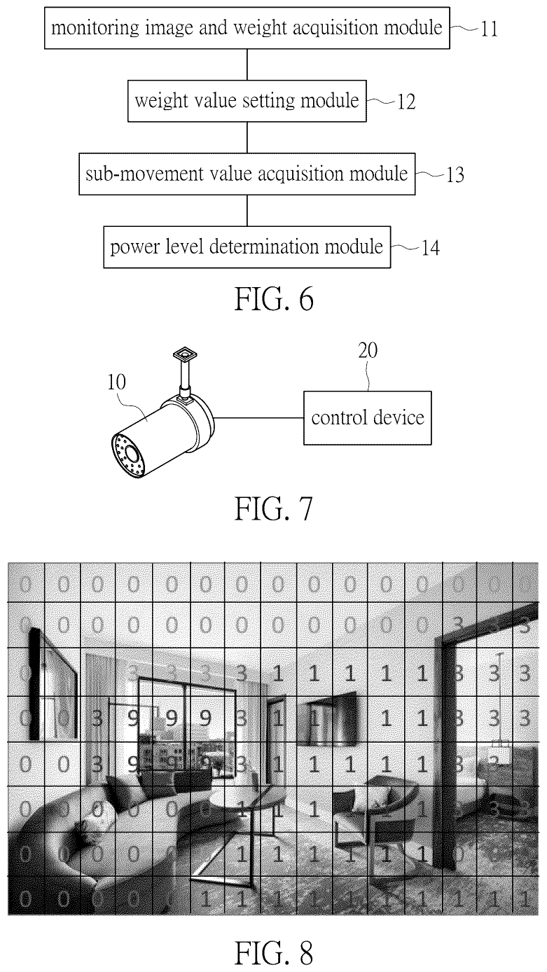

FIG. 6 is a schematic diagram of a control device for the monitoring equipment based on one embodiment of the present disclosure, the control device of the monitoring equipment can be implemented by a hardware and/or a software. The control device for the monitoring equipment includes a processor and a memory, the memory stores instructions including a monitoring image and weight acquisition module 11, a weight value setting module 12, a sub-movement value acquisition module 13, and a power level determination module 14.

The monitoring image and weight acquisition module 11 is configured to capture a monitoring image captured by the monitoring equipment and a weight setting range, and to divide the monitoring image into a plurality of sub-images arranged in an array format;

The weight value setting module 12 is configured to set a weight value of each sub-image according to the monitoring image and the weight setting range, wherein the weight value is within the weight setting range;

The sub-movement value acquisition module 13 is configured to control the monitoring equipment to capture the monitoring image in real time and to collect a sub-movement value of each sub-image in real time.

The power level determination module 14 is configured to determine a monitoring power level of the monitoring equipment based on both the sub-movement value and the weight value for each of the plurality of sub-images and to control the monitoring equipment to operate at the monitoring power level.

The control device for the monitoring equipment provided according to one embodiment of the present disclosure can perform the control method for the monitoring equipment provided according to any one embodiment of the present disclosure.

FIG. 7 is a schematic diagram of a monitoring system according to one embodiment of the present disclosure, and the monitoring system includes a monitoring equipment 10 and a control device 20. The control device 20 is communicatively connected to the monitoring equipment 10. The control device 20 may include a cloud server and a remote-control device that is communicatively connected to the cloud server, and may be set up according to actual needs. The control device 20 is used to execute the control method for the monitoring equipment provided according to any one embodiment of the present disclosure.

### Beneficial Effects of the Embodiments

In conclusion, in the control method and the control device for the monitoring equipment and the monitoring system provided by the present disclosure, the monitoring image captured by the monitoring equipment is divided into multiple sub-images arranged in an array format, and the weight value of each sub-image is set according to the user's attention level of each sub-image of the monitoring image. Then, the monitoring power level of the monitoring equipment is determined according to the sub-movement value of each sub-image and weight value of each sub-image. During the monitoring process of the monitoring equipment, the sub-movement values of each sub-image at different moments may be the same or different, so that the monitoring power levels of the monitoring equipment at the different moments are different and the monitoring equipment operates at a higher or a lower monitoring power level at the different moments during a working period of the monitoring equipment. When the monitoring equipment operates at the lower monitoring power level, the temperature generated by the monitoring equipment can be reduced, and the heat of components of the monitoring equipment can be dissipated at this stage, thereby reducing the working time of the monitoring equipment under extreme temperature conditions, or preventing the monitoring equipment from working under extreme temperature conditions, thereby improving the monitoring quality of the monitoring equipment and the service life of the monitoring equipment.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A control method for a monitoring equipment, comprising:
collecting, by a monitoring image and weight acquisition module, a monitoring image captured by the monitoring equipment and a weight setting range;
dividing, by a monitoring image and weight acquisition module, the monitoring image into a plurality of sub-images arranged in an array format;
setting, by a weight setting module, a weight value of each sub-image according to the monitoring image and the weight setting range, wherein each weight value is within the weight setting range;
controlling, by a sub-movement value acquisition module, the monitoring equipment to capture the monitoring image;
collecting, by the sub-movement value acquisition module, a sub-movement value of each sub-image in real time;
determining, by a power level determination module, a monitoring power level of the monitoring equipment based on both the sub-movement value and the weight value for each of the plurality of sub-images; and
controlling, by the power level determination module, the monitoring equipment to operate at the monitoring power level.

2. The control method according to claim 1, wherein setting the weight value includes:
determining an attention level for each sub-image based on an analysis of the monitoring image; and
setting the weight value for each sub-image based on its determined attention level.

3. The control method according to claim 2, wherein controlling the monitoring equipment to capture the monitoring image and the sub-movement value of each sub-image in real time includes:
identifying a changed sub-image by comparing a first image frame and a second, subsequent image frame;
for the changed sub-image, identifying an object associated with the change;
determining if the identified object is present in a predefined whitelist; and
if the object is present in the whitelist, assigning a first movement value to the changed sub-image; and
if the object is not present in the whitelist, assigning a second movement value, different from the first movement value, to the changed sub-image.

4. The control method according to claim 3, wherein if the sub-image exhibits no change between the first and second image frames, its sub-movement value is determined to be zero.

5. The control method according to claim 1, wherein determining the monitoring power level further comprises:
setting a product of the sub-movement value and the weight value as a weighted sub-movement value of each sub-image;
calculating a total movement value based on the weighted sub-movement value of each sub-image; and
determining the monitoring power level based on a mapping relationship between the total movement value and a plurality of power levels.

6. The control method according to claim 5, wherein calculating the total movement value of the monitoring image according to the weighted sub-movement value of each sub-image includes: setting a sum of the weighted sub-movement values of the sub-images as the total movement value.

7. The control method according to claim 1, comprising: capturing a sound intensity of an environment where the monitoring equipment is located when the monitoring power level is less than a maximum power level of the monitoring equipment; determining whether the sound intensity is greater than a preset intensity; if so, determining whether a sound of the environment in which the monitoring equipment is located belongs to a sound whitelist; and if so, controlling the monitoring equipment to operate at the monitoring power level.

8. The control method according to claim 7, wherein if the sound of the environment where the monitoring equipment is located does not belong to the sound whitelist, controlling the monitoring equipment to operate at the highest power level.

9. A control device for a monitoring equipment, comprising:
a processor;
a memory storing instructions that, when executed by the processor, cause the control device to perform the control method according to claim 1.

10. A monitoring system, comprising:
a monitoring equipment; and
a control device according to claim 9 communicatively connected to the monitoring equipment.
